(19) United States
(12) Patent Application Publication
(10) Pub. No.: US 2007/0169278 A1
(43) Pub. Date: Jul. 26, 2007

(54) Anti- viral fiber, process for producing the fiber, and textile product comprising the fiber

(75) Inventors: Shozo Shigita, Sanda-shi (JP); Hideyuki Tsurumi, Okayama-shi (JP); Hideo Naka, Okayama-shi (JP)

Correspondence Address: KENYON & KENYON LLP, 1500 K STREET N.W., SUITE 700, WASHINGTON, DC, 20005, US

(73) Assignees: JAPAN EXLAN CO., LTD., OSAKA (JP); TOYO BOSEKI KABUSHIKI KAISHA, OSAKA (JP)

(21) Appl. No.: 10/591,460

(22) PCT Filed: Mar. 1, 2005
(86) PCT No.: PCT/JP05/03837

§ 371 Date: Sep. 1, 2006

(30) Foreign Application Priority Data
Mar. 1, 2004 (JP) 2004-057307

(51) Int. Cl. C11D 3/00

(52) U.S. Cl. 8/115.51

(57) ABSTRACT

A fiber which has an excellent effect of inhibiting virus multiplication or eradication (deactivation); a process for producing the fiber; and a textile product comprising the fiber are provided. The method for producing an antiviral fiber comprises bonding a metal ion of a metal having deactivation effect to a virus and poor solubility in water to at least a part of a carboxyl group of the fiber having a cross-linked structure and having a carboxyl group in a molecule of the fiber; and then depositing fine particles of the metal and/or metal compound in the fiber by reduction and/or substitution reaction.

### FIELD OF THE INVENTION

The present invention relates to a textile material having effect of inhibition of multiplication or eradication of a virus, and exhibiting deactivation effect to a general virus.

### BACKGROUND ART

Virus infection occurs not only by direct contact to virus-containing splash by sneeze or the like discharged by a virus infected person, but also by contact (indirect contact) to clothes, towel, or the like having come in contact with a virus infected person. Mask is generally used for method of prevention of virus infection. However, since viruses will be condensed in a filter part of a mask after long use, contact to the mask body at the time of detaching of the mask will move the viruses to a hand, and contact of the infected hand to towel and clothes will then move the viruses to the towel or clothes. Further contact of a third person to a part where the viruses have attached then makes the viruses attach to the hand of the third person to cause secondary infection.

In consideration of such problems, techniques for inhibiting multiplication or eradicating of deposited viruses on various kind of textile products or the like have been proposed. Such techniques are described in Japanese Patent Publications of Unexamined Applications No. 2002-65879, No. 2001-245997, No. Hei 11-19238, No. Hei 09-225238.

### DISCLOSURE OF THE INVENTION

The present invention is completed for solving the above-mentioned situations. The purpose of the present invention is to provide a fiber having excellent effect of inhibiting virus multiplication or eradication, that is, deactivation; a method for producing the fiber; and a textile product comprising the fiber.

An antiviral fiber of the present invention, that can solve the above-described problems, is characterized in that fine particles of a metal and/or a metal compound are dispersed in the fiber; the fiber has a cross-linked structure and a carboxyl group in a molecule thereof; and the fine particles have deactivation effect to a virus and poor solubility in water.

Especially, the fiber in which at least a part of the carboxyl group exist in a form of a salt, preferably of an alkali metal salt, an alkaline earth metal salt, or a salt of ammonia, is recommendable, since such a salt exhibits more excellent virus deactivating effect, conjointly with moisture absorbing or moisture retaining function.

Especially the preferable metal and/or metal compound in the antiviral fiber of the present invention is at least one kind of a metal and/or a metal compound selected from a group consisting of Ag, Cu, Zn, Al, Mg and Ca, and a metal compound thereof. The antiviral fiber including not less than 0.2 mass % of finely dispersed fine particles thereof as metal is especially preferable, since the fiber exhibits virus deactivating effect at a high level. The fibrous antiviral fiber of the present invention can be processed into a cottony shape, a nonwoven fabric shape, a textile shape, a paper shape, or a knit shape by independent use, or by blending or filament mixing with other arbitrary fiber materials, the fiber can be put in practical use as material in various forms corresponding to usage. In order effectively to exhibit virus deactivating effect as these whole textile products, not less than 0.2 mass % in terms of metal of the antiviral fiber is preferably included in all the fiber components.

A method of the present invention is a preferable method for producing the above-described antiviral fiber and characterized by comprising bonding a metal ion of a metal having deactivation effect to a virus and poor solubility in water to at least a part of a carboxyl group of the fiber having a cross-linked structure and a carboxyl group in a molecule thereof; and then depositing fine particles of the metal and/or metal compound in the fiber by reduction and/or substitution reaction.

Especially preferable method for performing the above-described process of the present invention comprises using a fiber, wherein the fiber has a cross-linked acrylic fiber as a basic skeleton and at least a part of a functional group of a molecule of the cross-linked acrylic fiber is hydrolyzed, as the fiber having a cross-linked structure and having a carboxyl group in a molecule thereof; bonding the metal ion of a metal to at least a part of the carboxyl group; then depositing fine particles of the metal and/or metal compound in the fiber by a reduction and/or substitution reaction.

### BEST MODE FOR CARRYING-OUT OF THE INVENTION

An antiviral fiber of the present invention has a cross-linked structure and a carboxyl group in a molecule thereof, and fine particles of a metal and/or a metal compound having poor solubility in water are dispersed in the fiber.

At present, mechanisms of deactivation of a virus by the antiviral fiber have not yet been clarified. However, it is conceivable that contact of a virus with fine particles of the above-described poor water soluble metal and/or metal compound dispersed in the fiber may interrupt or destroy the work of a protein including an enzyme protein (envelope) and S protein (spike) that enclose nucleic acid of the virus. Anyway, the antiviral fiber of the present invention exhibits excellent virus deactivating effect.

Since the fiber of the present invention destroys s protein of a virus as mentioned above to exhibit virus deactivating effect, the fiber probably destroys proteins other than that of a virus. For example, use of the fiber of the present invention could destroy an allergen protein that is believed to be causative agent of pollinosis, and, as a result, could also inhibit onset of allergy.

As a fiber that forms a basic skeleton of the antiviral fiber of the present invention, any fiber having a carboxyl group in the molecule thereof and having a cross-linked structure can be used without any limitation. In consideration of productivity and strength property as a basic structural fiber, mass productivity, costs, or the like, the most preferable fiber includes acrylic fibers having a cross-linked structure given by various methods, and especially fibers having a carboxyl group introduced by partial hydrolysis of acrylonitrile fibers or acrylic ester fibers.

The cross-linked structures given to the fiber have functions for guaranteeing a moderate strength as a fiber when the carboxyl group is introduced, for realizing insolubility in water, and further for avoiding physical and chemical degradation in case of blending a metal and/or a metal compound having poor solubility in water to the fiber by methods described later. The cross-linked structures include all cross-linked structures such as cross-linking by covalent bond, ion cross-linking, and chelate cross-linking. Methods of introducing cross-linking is not especially limited, and preferred is introduction of the cross-link after processing to fibrous state by spinning, drawing, or the like using conventional methods in consideration of easy processing to fibrous state.

By a method of use of an acrylonitrile polymer as a fiber material and of introduction of a cross-linked structure by hydrazine or the like thereinto, the fiber not only has excellent physical properties, but also easily can have a higher content of fine particles of the metal and/or metal compound with poor solubility in water by a method described later. Since the method may also provide excellent heat-resisting properties to the fiber at lower costs, the method may be recommended as a method with a high practicality.

By the way, the deactivation effect by fine particles of the metal and/or metal compound included in the fiber is caused by contact of a virus to the fine particles. It is conceivable that coexistence of a functional group such as an alkali salt of carboxyl group included in the fiber, having moisture absorbing or moisture retaining functions, may ionize a little amount of a metal by contact with water to give improved virus deactivating effect. When the fiber have moisture absorbing or moisture retaining function, even without direct touch of a virus to the above-described fine particles, the fiber can exhibit the deactivation effect against, for example, viruses sensitive to humidity, such as influenza virus. Such moisture absorbing or moisture retaining function can be realized by making at least a part of a carboxyl group in the fiber molecule exist as a salt.

Accordingly, in order to give higher moisture absorbing or moisture retaining function to the fiber, the fiber having a cross-linked structure preferably includes at least a part of a carboxyl group that exists as a salt such as, for example, salt of alkali metal, alkaline earth metal, or ammonia. Especially, a salt existing as alkali metal salt such as sodium and potassium salt can preferably give higher moisture absorbing or moisture retaining function to the fiber, even in smaller substituted amount of the metal salt.

In this way, the fiber having a salt of the above-described carboxyl group can exhibit higher virus deactivating effect by conjoint effect of function of the metal and/or metal compound in micro-dispersion in cross-linked fiber, and of moisture absorbing or moisture retaining function originating in salt of carboxyl group included in the fiber molecule.

The present invention is effective especially against a virus having property extremely sensitive to humidity, such as influenza virus, and thereby the present invention exhibits virus deactivating effect by the moisture absorbing or moisture retaining function even in a spot without contact between the metal and/or metal compound existing in the fiber and virus.

Introduction of a carboxyl group into the above-described fiber molecule can be performed by publicly known methods such as hydrolysis reaction, oxidation reaction, and condensation reaction. For example, in the case of acrylonitrile fiber or acrylic ester fiber, the above-described introduction can be usually performed by hydrolysis of a nitrile group or an acid ester group after processing into fibrous shape, followed by introduction of cross-linking. Introduction amount of the carboxyl group may be determined, based on degrees of moisture absorbing or moisture retaining function to be given to the fiber, or in consideration of introduction amount of salt such as alkali metal described later. Introduction amount preferable in order to obtain more excellent virus deactivating effect is preferably not less than 0.1 mmol per 1 g of the fiber in terms of carboxyl group, and more preferably not less than 3 mmol, and preferably not more than 10 mmol. Moreover, preferably not less than 60 mol %, and more preferably not less than 80 mol % of the carboxyl group are neutralized with alkali metal or the like.

As the metal and/or metal compound to be included in the fiber having a carboxyl group, all of a metal and/or a metal compound having a deactivation effect with respect to a virus and poor solubility in water may be used.

Poor solubility in water means that a concerned material is substantially insoluble in water at ordinary temperatures, and that coexistence with water on usual condition of use, such as ordinary temperatures and normal pressures, does not allow substantial dissolution of the metals and/or metal compound from the fiber. Substantially insoluble means that a solubility constant of the metal and metal compound is nearly not more than 10⁻⁵ at room temperatures, or that solubility is not more than 10⁻³ g/g.

Materials preferable for obtaining more excellent virus deactivating effect include: metals such as silver, copper, zinc, manganese, iron, nickel, aluminium, tin, molybdenum, magnesium, calcium; and oxides, hydroxides, chlorides, bromides, iodides, carbonates, sulphates, phosphates, chlorates, bromates, iodates, sulfites, thiosulfates, thiocyanates, pyrophosphates, polyphosphates, silicates, aluminates, tungstates, vanadates, molybdates, antimonates, benzoates, dicarboxylic acid salts of the above-mentioned metals, and the like. These may be used independently, and two or more kinds may be used in combination. As material exhibiting excellent virus deactivating effect among them, at least one kind of metal selected from a group consisting of Ag, Cu, Zn, Al, Mg and Ca, and/or metal compound is more preferred, and silver, silver compound, copper, and copper compound are especially preferred.

A size of these fine particles of the metal and/or metal compound (hereinafter referred to as metal fine particles) is not especially limited. In order to exhibit more effective deactivation effect over a virus, the fine particles preferably have a size as small as possible and a surface area as large as possible, and the size of the fine particles is especially preferably not more than 1 μm.

The form of the fiber containing these fine particles of the metal and/or metal compound is not especially limited. In order to further improve virus deactivating effect, since the fiber has a surface area per unit mass as large as possible, and allow effective use of the metal and/or metal compound within the fiber, the above-described fiber preferably have a porous structure. Especially, the fiber preferably have pores with a size of approximately not more than 1 μm, and have open cell porous structure communicating to external environment.

The content of the poor soluble metal or metal compound in water, that is, content as metal, is not especially limited. In order to obtain sufficient virus deactivating effect, the poor soluble metal and metal compound in water are preferably included in an amount not less than 0.2 mass % in terms of metal with respect to a mass of the antiviral fiber, and more preferably not less than 0.4 mass %. A larger content preferably exhibits higher virus deactivating effect, but since a larger content may possibly raise costs and deteriorate fiber physical properties, the content is preferably not more than 15 mass %, and more preferably not more than 8 mass %.

The content of the metal and metal compound in the antiviral fiber may be calculated from a value measured by an atomic absorption method (made by Shimadzu Corporation: atomic absorption spectrophotometer AA-6800) after wet degradation of the fiber with a mixed liquor of nitric acid, sulfuric acid, and perchloric acid (the concentration is to be adjusted corresponding to decomposition conditions). For example, the content of silver and/or silver compound in the fiber may be measured and calculated by using an atomic absorption method after wet degradation of the fiber with a mixed liquor ((98% sulfuric acid) 1: (60% of nitric acid) 3 to 5: (60% perchloric acid) 1 to 2).

A virus to be the subject to the deactivation effect in the present invention is not based on kind of genome, existence of envelopes, or the like, and include all viruses. For example, viruses having DNA as a genome include herpesvirus, smallpox virus, cowpox virus, chicken pox virus, adenovirus, or the like, and viruses having RNA as a genome include measles virus, influenza virus, coxsackie virus, or the like. Among these viruses, viruses having envelopes include herpesvirus, smallpox virus, cowpox virus, chicken pox virus, measles virus, influenza virus, or the like, and viruses without envelopes include adenovirus, Coxsackie virus, or the like.

The antiviral fiber of the present invention is a fiber having a cross-linked structure and including the metal and/or metal compound which is poorly soluble in water, as mentioned above. As the method of production, following (I) and (II) are employable.

(I) blending the metal and/or metal compound into a polymer forming the fiber, and spinning the polymer into the fiber;

(II) bonding a metal ion of the above-mentioned metal to the carboxyl group in the fiber, then withdrawing the metal ion from the carboxyl group with a chemical reaction, and depositing the metal and/or metal compound within the fiber.

Especially preferable method is the above-described (II) among these methods, and concrete description of the method will, hereinafter, be given, with a reference case of blending silver or copper compound into a cross-linked acrylic fiber.

A cross-linked acrylic fiber may be produced by publicly known methods. For example, a cross-link structure may be introduced by processing of an acrylic fiber with hydrazine compound or the like. Since the fiber through this step loses solubility to water or a common solvent by this cross-linking introduction processing, the processing into fiber like a spinning processing needs to be performed before the cross-link structure introduction processing.

Subsequently, a nitrile group and an acid ester group in the molecule of the cross-linked acrylic fiber are hydrolyzed by processing of the cross-linked acrylic fiber with acid or alkali. The processing by acid gives an H type carboxyl group, and the processing by alkali gives an alkali metal salt type carboxyl group. The amount of the carboxyl group formed increases with progress of hydrolysis. In order to efficiently improve the content of silver or copper or the compound thereof in a next step, the formed amount as the carboxyl group is preferably not less than 0.1 mmol/g, and more preferably not less than 3 mmol/g, and preferably not more than 10 mmol/g, and more preferably not more than 8 mmol/g. A formed amount of not less than approximately 0.1 mmol/g can fully improve the content of the silver or copper or the compound thereof, leading to further excellent virus deactivating effect. Although carboxylation exceeding 10 mmol/g exhibits virus deactivating effect, such carboxylation may possibly deteriorate the fiber physical properties.

Subsequent processing of the cross-linked acrylic fiber including introduced carboxyl group or metal salt thereof by silver ion aqueous solution or copper ion aqueous solution combines the silver ion or copper ion with the carboxyl group in the fiber molecule.

In case of producing a cross-linked acrylic fiber, (that is, an antiviral fiber) including metal silver or metal copper, a reduction processing of the silver ion or copper ion bonded with the carboxyl group can provide the fiber. In case of producing a cross-linked acrylic fiber including silver or copper compound, processing by aqueous solution including a compound that allows deposition of the slightly soluble compound in water by bonding with the silver ion or the copper ion may provide the fiber.

Reducing method to be adopted in this case is not especially limited as long as it is a method to reduce a metal ion into a corresponding metal. The method includes for example, a method of reduction in aqueous solution using reducing agent such as compound that can give electron to a metal ion, in detail, sodium borohydride, hydrazine, formaldehyde, compound having aldehyde group, hydrazine sulfate, hydrocyanic acid and salt thereof, hyposulfurous acid and salt thereof, thiosulfuric acid, hydrogen peroxide, Rochelle salt, hypophosphorous acid and salt thereof, or the like; method of heat treatment in reducing atmospheres such as hydrogen and carbon monoxide; method using light radiation; and method in suitable combination of the above-described methods, or the like.

In the case of the reduction reaction in an aqueous solution, suitable inclusion of: pH adjuster such as basic compound such as sodium hydroxide and ammonium hydroxide, inorganic acid, and organic acid; buffering agent such as alkali salt of oxycarboxylic acid compound such as sodium citrate, inorganic acid such as boric acid and carbonic acid, organic acid, and inorganic acid; accelerator such as fluoride; stabilizer such as chloride, brominated compound, nitrate; surface-active agent, or the like, in the system of reaction is effective.

The kind of compound allowing deposition of compound with poor solubility in water by bonding with silver or copper ion is not especially limited. For example, the compound includes: oxides, hydroxides, chlorides, bromides, iodides, carbonates, sulphates, phosphates, chlorates, bromates, iodates, sulfites, thiosulfates, thiocyanates, pyrophosphates, polyphosphates, silicates, aluminates, tungstates, vanadates, molybdates, antimonates, benzoates, dicarboxylicates, or the like.

Silver or copper or compound thereof formed by the above-described reduction and/or substitution reaction are left as metal ion from the carboxyl group in the fiber molecule by the above-described reduction and/or substitution reaction, and at the same time they are formed to be deposited in the vicinity of the fiber molecule as minute and poor soluble compound in water. Accordingly, water rinsing and drying of the fiber may homogenously deposit extremely minute granular material of the metal or metal compound inside the fiber or on an external surface of the fiber. Furthermore, alkali neutralization process (for example, process of immersion in an alkali solution having a pH value adjusted with sodium hydroxide or the like) of the fiber may neutralize the carboxyl group with alkali metal, and thus may give moisture retaining function to the fiber. That is, since the silver or copper or compound thereof included in a state of being deposited in the cross-linked fiber exists in the cross-linked fiber in a state of being very minute and having a large surface area (that is, contact interface with virus), contact between the virus and the minute granular silver or copper or compound thereof in the fiber will lead to immediate deactivation of the virus. It is conceivable that, concerning the virus deactivation function by the above-described metal and/or metal compound, existence of functional group having moisture absorbing or moisture retaining function, such as an alkali salt of carboxyl group, included in the fiber may ionize a small amount of metal by contact with water, leading to more enhanced virus deactivating effect.

An antiviral fiber of the present invention has the above-described characteristics, and the appearance shape may take various forms. For example, the fiber may be used as textile products in any shapes such as spun yarn, yarn including wrap yarn, filament, nonwoven fabric, textile, knitted fabric, sheet shaped material, mat shaped material, cottony material, material in a shape of paper, and layered product. In addition, the cross-linked fiber of the present invention having the above-described virus deactivating effect may be used independently, and the above-described textile products may also be obtained by mixing (containing co-spinning and mixing filaments) with other natural fiber, synthetic fiber, semi-synthetic fiber, or the like, if needed.

The fiber with cross-linked structure including the metal and/or metal compound, and furthermore the fiber with cross-linked structure including coexisting salt of the carboxyl group having moisture absorbing or moisture retaining function and the metal and/or metal compound can exhibit excellent virus deactivating effect also in the textile product obtained by mixing with other fibers.

In the case of mixed use of the antiviral fiber with other fiber, in order to enhance virus deactivating effect of textile product, the metal and/or metal compound is included in an amount of preferably not less than 0.2 mass %, more preferably not less than 0.4 mass %, and still more preferably not less than 0.8 mass % in terms of metal in all fiber component. The upper limit is not especially limited, but since there may be possibility of deterioration of physical properties such as strength, the upper limit is preferably not more than 15 mass %, more preferably not more than 8 mass %, and still more preferably not more than 5 mass %.

From a viewpoint of prevention from infection by virus, examples of detailed textile product include mask, clothes, personal goods made of cloth, environmental article, medical material. Further, the antiviral fiber of the present invention may be used for all textile products as constituent material, other than these examples.

Examples of the masks include general commercial item and medical use mask;

Personal goods made of cloth include cloth products having possible direct contact to hands, such as handkerchief, towel, necktie, glasses-wiping cloth, dustcloth, and dishcloth;

Clothes include various cloth products such as dressing gown, apron, trousers, scrub suit, white robe, and shoe cover;

Personal goods include cloth products such as cap, sheet, pillow case, dressing, absorbent gauze, filter, shoes, and gloves;

Environmental article includes cloth products such as filter for air cleaner, filter for air-conditioner, filter for ventilation fan, filter for sterile room, wallpaper, partition, chair tension, outer skin material for ceiling, carpet, and tablecloth;

Medical material includes various cloth products such as suture, adhesive bandage, and other disposable materials.

Textile products other than the above-mentioned examples include: cloth products such as dress material, underwear, lining cloth, shirt, blouse, sweat pants, working wear, toweling, scarf, socks, stocking, sweater, footwear and supporter; bedclothing implement products such as curtain, wadding, carpet, furniture cover, padding cloth, insoles, inner material for shoes, bag cloth, headrest cover, blanket, sheets, beddings, or the like. In addition, daily necessaries such as mops, chemistry dustcloth, and toilet cleaner may be exemplified.

Hereinafter, descriptions on virus deactivation evaluation method of the fiber of the present invention and textile products will be given.

Conventionally, a standard evaluation method by SEK (abbreviation of JAFET (Japan Association for the Functional Evaluation of Textiles)) has been established for antibacterial properties and antifungus properties of fiber or textile product. However, it is difficult to use the antibacterial and antifungal evaluation method concerned to the antiviral nature of fiber or textile product, and furthermore, a standard valuation method on antiviral evaluation has not yet been established.

For example, since the size of s virus is as small as about 20 to 200 nm ( 1/10 to 1/100 of bacteria), light microscope and electron microscope do not allow easy observation of growth and inhibition of a virus. Furthermore, since a virus does not form colony unlike bacteria, observation by naked eye does not allow easy identification of growth and inhibition, either. In addition, since a virus needs a host cell for growing, it is difficult to directly grow and cultivate, and to evaluate growth and inhibition as in bacteria. Growth of virus is complicated as compared with growth of cell, and needs long period of time. Furthermore, since effect of antiviral drug greatly varies with kind of virus, uniform evaluation is difficult.

Accordingly, although any evaluation methods publicly known as antiviral evaluation for a evaluation method of the fiber and textile product of the present invention may be used, it is preferred to use conventionally publicly known 50% infectivity titer method (TCID₅₀) or plaque method (PFU) in view of wider usability, reliability, simplicity, safety, and economical efficiency.

More detailed description of the present invention will, hereinafter, be given with reference to Examples. However, following Examples are only illustrative examples selected from the above-described requirements, and suitable modification based on the above-described descriptions can also provide effect of the present invention. Therefore, the present invention is of course not limited by the following Examples, implementation accompanied by suitable modification within limits being adapted to the spirit of the present invention may be performed, and each of them is included in the technical scope of the present invention. Evaluation methods adopted in the Examples will be shown below.

### EXAMPLES

### Example 1

Deactivation effect of a virus was examined using samples No. 1 to 5. Deactivation test method is based on followings.

Measuring Method of Carboxyl Group

A sample 1 g was opened, and then was immersed in 1 mol/L hydrochloric acid 50 mL with stirring. After the pH value was adjusted to be not more than 2.5, the sample was removed out and rinsed with ion exchanged water. Subsequently, the sample was dehydrated, and cut after drying with hot air drying equipment (made by Yamato Scientific Co., Ltd. type DK 400) at 105° C. The sample 0.2 g was precisely weighed and was added in a beaker. The weight of 0.2 g was represented as W1 (g) in the following equation. Then, distilled water 100 mL, 0.1 mol/L sodium hydroxide aqueous solution 15 mL, and sodium chloride 0.4 g were added into the beaker, and the mixture was stirred for not less than 15 minutes. After filtration the mixture, the obtained filtrate was titrated with 0.1 mol/L hydrochloric acid. Phenolphthalein was used as indicator. The value (mL) of the titration was represented as X1 (mL) in the following equation. An amount of carboxyl group [Y (mmol/g)] was calculated using the following equation.
Amount of the carboxyl group [Y(mmol/g)]=(0.1×15−0.1 ×X1)/W1
Measuring Method of Neutralization Degree

A sample 1 g was opened, dried with hot air dryer at 105° C., and then cut. The sample 0.4 g was precisely weighed, and added into a beaker. The weight of 0.4 g was represented as W2 (g) in the following equation. Then, ion exchanged water 100 mL, sodium hydroxide aqueous solution with 0.1 mol/L concentration 15 mL, and sodium chloride 0.4 g were added into the beaker, and the mixture was stirred for not less than 15 minutes. After filtration of the mixture, the obtained filtrate was titrated with 0.1 mol/L hydrochloric acid. Phenolphthalein was used as indicator. The value (mL) of the titration was represented as X2 (mL) in the following equation. An amount of H type carboxyl group [Z (mmol/g)] was calculated using the following equation.
Amount of H type carboxyl group[Z (mmol/g)]=(0.1×15−0.1×X2)/W2

A degree of neutralization was calculated by using the following equation from the obtained amount of H type carboxyl group (Z), and the amount of carboxyl group (Y) obtained by the above-described measuring method of carboxyl group.
Degree of neutralization(%)=(Y−Z)/Y×100
Examined Virus

For samples No. 1 to 10, type A influenza virus, so-called Russian flu, [A/New Caledonia/20/99 (H1N1)], was used as an examination virus. For samples No. 11 to 13, as examination viruses used were: the herpes simplex virus 1F strain, cowpox virus strain, the measles virus Toyoshima strain, the adenovirus type 5, the Type A human influenza virus [A/PR/8/34 (H1N1)], and the type B5 coxsackie virus. Since antiviral examination using a smallpox virus is difficult to be performed in consideration of a problem of handling, the cowpox virus that is a virus similar to a smallpox virus was used as an alternative virus.

Deactivation Examination

50% infectivity titer method (TCID₅₀)

After a sample and a blank sample (sample No. 5) each 2 g were put into 50 mL test tubes, a virus solution 45 mL was added into the test tubes. After shaking for 22 hours at 25° C., a solution 5 mL was taken from the test tube, and the solution was subjected to centrifugal separation processing (for 3000 rpm, 30 minutes). After centrifugal separation processing, the obtained supernatant was serially diluted by 10 times, TCID₅₀ (50% infectivity titer) was measured by using Madin-Darby Canine Kidney cell (MDCK cell) to calculate a viral infectivity log₁₀ (TCID₅₀/mL).

The deactivation rate of virus was calculated from the following equation by using obtained viral infectivity.
Rate of virus deactivation(%)=100×(10^{(viral infectivity of blank)}−10^{(viral infectivity of sample)}/(10^{(viral infectivity of blank)})
Sample No. 1

Acrylonitrile copolymer consisting of acrylonitrile 90 mass % and vinyl acetate 10 mass % (intrinsic viscosity [η]=1.2 in dimethylformamide at 30° C.) 10 mass parts were dissolved in a 48 mass % rhodan soda aqueous solution 90 mass parts to obtain a spinning solution. After the obtained spinning solution was spun and drawn (whole draw ratio: 10 times) according to a conventional method, the obtained filament was subjected to drying and moist heat treatment under an atmosphere of dry bulb/wet bulb=120° C./60° C. to obtain a raw material fiber (single fiber fineness 0.9 dtex, 51 mm of fiber length).

Processing for cross-linking introduction for 5 hours at 98° C. was given to this raw material fiber in hydrazine hydrate 20 mass % aqueous solution, and then the fiber was rinsed with pure water. After rinsing and drying, the fiber was subjected to acid treatment in 3 mass % nitric acid for 2 hours at 90° C., and subsequently to hydrolysis treatment in sodium hydroxide 3 mass % aqueous solution for 2 hours at 90° C., and finally rinsed with pure water. The obtained fiber had 5.5 mmol/g of Na type carboxyl group introduced into molecule thereof. After acid treatment of this fiber in 5 mass % nitric acid for 30 minutes at 60° C., the fiber was rinsed with pure water. Oil was added to the fiber, and the fiber was furthermore dehydrated and dried to obtain a cross-linked acrylic fiber. The cross-linked acrylic fiber was subjected to ion exchange reaction for 30 minutes at 70° C. by immersion into 0.1 mass % silver nitrate aqueous solution having a pH value of 1.5 adjusted with nitric acid solution. Then, the fiber was dehydrated, rinsed with pure water, and dried to obtain a silver ion-exchanged fiber. Furthermore, the fiber was dipped in an alkali solution having a pH value of 12.5 adjusted with sodium hydroxide aqueous solution for 30 minutes at 80° C. A antiviral fiber (Fiber 1) which is fibrous and includes Ag particle 1.0 mass % deposited therein was obtained by this processing.

The fiber was measured for Ag content by an atomic absorption method, after wet degradation of the fiber with a mixed solution (nitric acid, sulfuric acid, perchloric acid).

A needle punched nonwoven fabric (sample No. 1) having a weight of 100 g/m² was obtained using this Fiber 1 under 20° C. and 65% RH environment. This nonwoven fabric was evaluated for a deactivation effect over influenza viruses using the 50% infectivity titer method. Table 1 shows the result.

Samples No. 2 to No. 4

The above-described Fiber 1 and a polyethylene terephthalate staple fiber (fiber length: 38 mm, fineness: 0.9 dtex) were blended at a ratio of 80:20 to obtain a needle punched nonwoven fabric having a weight of 100 g/m² under 20° C. and 65% RH environment (sample No. 2). Sample No. 3, and sample No. 4 were obtained in a same manner as in sample No. 2, except for having changed the ratio of the above-described Fiber 1 and the polyethylene terephthalate staple fiber into 40:60 and into 20:80, respectively. These nonwoven fabrics were evaluated for a deactivation effect over the influenza viruses using the 50% infectivity titer method. Table 1 shows the result.

Sample No. 5 (blank)

A needle punched nonwoven fabric (sample No. 5) having a weight of 100 g/m² was obtained by using a polyethylene terephthalate staple fiber (fiber length: 38 mm, fineness: 0.9 dtex) under 20° C. and 65% RH environment. This needle punched nonwoven fabric was evaluated for a deactivation effect over influenza virus by using the 50% infectivity titer method. Table 1 shows the result.

TABLE 1

| | Ag particle (%) | Influenza deactivation rate (%) |
|---|---|---|
| Sample No. 1 | 1.0 | >99.99 |
| Sample No. 2 | 0.8 | 99.98 |
| Sample No. 3 | 0.4 | 99.87 |
| Sample No. 4 | 0.2 | 99.15 |
| Sample No. 5 | 0 | 0 |

### Example 2

Samples No. 6 to 10 were examined for a deactivation effect to virus. Deactivation test method is same as that in the above-described Example 1.

Sample No. 6 The needle punched nonwoven fabric of the sample No. 1 of the above-described Example 1 was used.

Sample No. 7

A needle punched nonwoven fabric (sample No. 7) was obtained in a same manner as in sample No. 1, except that the cross-linked acrylic fiber of the sample No. 1 in the above-described Example 1 was immersed in 0.08 mass % silver nitrate aqueous solution having a pH value adjusted to 1.5 with nitric acid to perform ion exchange reaction for 30 minutes at 70° C., and the fiber was then subjected to dehydrating treatment, rinse with pure water, and drying process to obtain a silver ion-exchanged fiber. The fiber included 0.8 mass % of Ag fine particle deposited therein.

Sample No. 8

A needle punched nonwoven fabric (sample No. 8) was obtained in a same manner as in sample No. 1, except that the cross-linked acrylic fiber of the sample No. 1 in the above-described Example 1 was immersed in 0.04 mass % silver nitrate aqueous solution having a pH value adjusted to 1.5 with nitric acid to perform ion exchange reaction for 30 minutes at 70° C., and the fiber was then subjected to dehydrating treatment, rinse with pure water, and drying process to obtain a silver ion-exchanged fiber. The fiber included 0.4 mass % of Ag fine particles deposited therein.

Sample No. 9

A needle punched nonwoven fabric (sample No. 9) was obtained in a same manner as in sample No. 1, except that the cross-linked acrylic fiber of the sample No. 1 in the above-described Example 1 was immersed in 0.02 mass % silver nitrate aqueous solution having a pH value adjusted to 1.5 with nitric acid to perform ion exchange reaction for 30 minutes at 70° C., and the fiber was then subjected to dehydrating treatment, rinse with pure water, and drying process to obtain a silver ion-exchanged fiber. The fiber included 0.2 mass % of Ag fine particles deposited therein.

Sample No. 10

The needle punched nonwoven fabric of sample No. 5 of the above-described Example 1 was used.

Samples No. 6 to 10 were evaluated for deactivation effect over influenza virus. Table 2 shows the result.

TABLE 2

| | Ag particle (%) | Influenza deactivation rate (%) |
|---|---|---|
| Sample No. 6 | 1.0 | >99.99 |
| Sample No. 7 | 0.8 | 99.99 |
| Sample No. 8 | 0.4 | 99.95 |
| Sample No. 9 | 0.2 | 99.50 |
| Sample No. 10 | 0 | 0 |

### Example 3

The samples No. 11 to 13 were evaluated for deactivation effect for virus. In deactivation test method, the following 50% infectivity titer method or the plaque method was used, corresponding to virus kinds, as shown in Table 3.

Deactivation Examination

50% infectivity titer method (TCID₅₀)

Except that samples 11 and 12 were used so that the fiber concentration might give 10 mg/mL, the same operation as in Example 1 was repeated to calculate a viral infectivity log₁₀ (TCID₅₀/mL) and a virus deactivation rate. In addition, the same operation as Example 1 was repeated for sample 13 to calculate a viral infectivity log₁₀(TCID₅₀/mL) and a virus deactivation rate without using the sample fiber.

Plaque Method (PFU)

African green monkey kidney (Verod cell) was added into a culture medium including MEM (Minimum essential medium)/fetal bovine serum=9/1 (hereinafter, referred to as MEM medium). The MEM medium was added into 24-well microplate, and cultivated to obtain a cell monolayer film.

On the other hand, a cryopreserved virus in a vial was divided into a balanced salt solution (PBS) so that one vial might give 100 mL to obtain a virus liquid. For samples 11 and 12, the virus liquid 10 mL was added to a sample fiber 10 mg or 100 mg cut into a length of 2 to 3 mm so as to give fiber concentrations shown in Table3 according to virus kinds. After stirring by a level rotating method for 1 hour, the vial was subjected to centrifugal separation under conditions of 2000 rpm and for 10 minutes. After the obtained supernatant was diluted with the above-described MEM culture medium so as to give a dilution magnification of 10⁰ to 10³, 0.1 mL of inoculation was given to the above-described cultured cell monolayer film, and the virus was adsorbed at 37° C. for 1 hour. A methylcellulose liquid was further poured to form a layer, and cultivated during 2 to 3 days at 37° C.

Then, living cells were stained by crystal violet, and the number of dead cells (plaque) as a non-stained section was counted. From these counted data, a viral infectivity log₁₀ (PFU/mL); (PFU: plaque-forming units) was calculated.

In addition, the same operation as described above was repeated to calculate a viral infectivity log₁₀ (PFU/mL) without using any sample, concerning sample 13.

Furthermore, the deactivation rate of virus was calculated from the following equation using the obtained viral infectivities.
Rate of virus deactivation(%)=100×(10^{(viral infectivity of blank)}−10^{(viral infectivity of sample)})/(10^{(viral infectivity of blank)})
Sample No. 11

The cross-linked acrylic fiber of sample No. 1 of the above-described Example 1 was immersed into a 0.09 mass % silver nitrate aqueous solution having a pH value adjusted to 1.5 with nitric acid to perform ion exchange reaction for 30 minutes at 70° C. Then, the fiber was subjected to dehydrating treatment, rinse with pure water, and drying process to obtain a silver ion-exchanged fiber. Furthermore, the fiber was immersed in an alkali solution having a pH value adjusted to 12.5 with sodium hydroxide aqueous solution for 30 minutes at 80° C. A fibrous antiviral fiber including Ag fine particles of 0.9 mass % deposited therein was obtained by this processing.

The fiber was measured for an Ag content therein by an atomic absorption method, after wet degradation of the fiber with a mixed solution (nitric acid, sulfuric acid, perchloric acid).

Sample No. 12

The raw material fiber of sample No. 1 of the above-described Example 1 was used.

Sample No. 13 (blank)

No fiber was used in this sample for a blank test.

The fiber and blank of samples No. 11 to 13 were evaluated for the deactivation effect over viruses. Table 3 shows used viruses and deactivation examination. Table 4 shows deactivation test results.

TABLE 3

| | Virus kind | | | | | |
|---|---|---|---|---|---|---|
| | Herpes | Cowpox | Measles | Adeno | Influenza | Coxsackie |
| Envelope | with | with | with | without | with | without |
| Genome | DNA | DNA | RNA | DNA | RNA | RNA |
| Evaluation | Plaque | Plaque | 50% | 50% | 50% | Plaque |
| method | technique | technique | infectivity | infectivity | infectivity | technique |
| | | | titer method | titer method | titer method | |
| Fiber | 1 | 10 | 10 | 10 | 10 | 10 |
| concentration | | | | | | |
| (mg/mL) | | | | | | |

TABLE 4

| | | | | Virus kind | | | | | |
|---|---|---|---|---|---|---|---|---|---|
| | Fiber* | Component | Content (mass %) | Herpes | Cowpox | Measles | Adeno | Influenza | Coxsackie |
| Sample | exist | Ag particles | 0.9 | 100.00 | 99.02 | 99.96 | 98.84 | 99.44 | 99.99 |
| No. 11 | | | | | | | | | |
| Sample | not | — | 0 | 32.39 | 18.72 | 0.00 | 0.00 | 0.00 | 0.00 |
| No. 12 | exist | | | | | | | | |
| Sample | — | — | 0 | 0 | 0 | 0 | 0 | 0 | 0 |
| No. 13 | | | | | | | | | |

*Existence of carboxyl group

The sample 11 as a fiber of the present invention exhibited excellent deactivation effect to each virus, irrespective of existence of envelopes and types of genome. That is, it was clarified that the sample has excellent deactivation effect to general viruses. In addition, it was recognized that the sample had excellent virus deactivation effect also to smallpox virus being similar to the cowpox virus, and therefore the fiber of the present invention probably has excellent deactivation effect also to the smallpox virus. On the other hand, the sample 12 that did not include either of poor water soluble metal and/or metal compound or carboxyl group did not show excellent antiviral nature to any viruses.

In consideration of the above results, it was clarified that the fiber of the present invention has excellent deactivation effect to general viruses. In addition, textile products including the fiber also have excellent deactivation effect to general viruses.

### INDUSTRIAL APPLICABILITY

An antiviral fiber of the present invention exhibits excellent effect of inhibition of multiplication or eradication of a virus, that is, deactivation for inhibiting activity of a virus. Therefore, textile product including the antiviral fiber of the present invention also exhibit excellent deactivation effect and exhibit effect for prevention of problems of virus infection by indirect contact.

The producing method of the present invention is preferable as a method for producing the antiviral fiber excellent in the above-described virus deactivating effect.

An antiviral fiber of the present invention exhibits excellent deactivation effect to general viruses at large, particularly to a herpesvirus, a smallpox virus, a measles virus, an adenovirus, an influenza virus, a Coxsackie virus.

Furthermore, textile products including the antiviral fiber of the present invention similarly exhibits excellent effect to general viruses.

1. An antiviral fiber, wherein
fine particles of a metal and/or a metal compound are dispersed in the fiber;
the fiber has a cross-linked structure and a carboxyl group in a molecule thereof; and
the fine particles have deactivation effect to a virus and poor solubility in water.

2. The antiviral fiber according to claim 1, wherein at least a part of the carboxyl group exists as a salt.

3. The antiviral fiber according to claim 1 [[or 2]], wherein the metal and/or metal compound is at least one kind selected from a group consisting of Ag, Cu, Zn, Al, Mg, and Ca, and a metal compound thereof.

4. The antiviral fiber according to claim 1, wherein the metal and/or metal compound is included at not less than 0.2 mass % as a metal in the fiber component.

5. An antiviral textile product, comprising the antiviral fiber according to claim 1, in cottony shape, non-woven fabric shape, textile shape, paper shape, or knitted fabric shape.

6. The antiviral textile product according to claim 5, wherein the metal and/or metal compound is included at not less than 0.2 mass % as a metal in whole of the fiber component.

7. A method for producing an antiviral fiber, comprising:
bonding a metal ion of a metal having deactivation effect to a virus and poor solubility in water to at least a part of a carboxyl group of a fiber having a cross-linked structure and a carboxyl group in a molecule thereof; and
then depositing fine particles of the metal and/or metal compound in the fiber by reduction and/or substitution reaction.

8. The method for producing an antiviral fiber according to claim 7, comprising:
using a fiber, wherein the fiber has a cross-linked acrylic fiber as a basic skeleton and at least a part of a functional group of a molecule of the cross-linked acrylic fiber is hydrolyzed, as the fiber having a cross-linked structure and having a carboxyl group in a molecule thereof;
bonding the metal ion of a metal to at least a part of the carboxyl group;
then depositing fine particles of the metal and/or metal compound in the fiber by reduction and/or substitution reaction.

9. The antiviral fiber according to claim 2, wherein the metal and/or metal compound is included at not less than 0.2 mass % as a metal in the fiber component.

10. The antiviral fiber according to claim 3, wherein the metal and/or metal compound is included at not less than 0.2 mass % as a metal in the fiber component.
